(19) United States
(12) Patent Application Publication
(10) Pub. No.: US 2025/0155603 A1
(43) Pub. Date: May 15, 2025

(54) METASURFACE ENABLED QUANTITATIVE PHASE IMAGING

(71) Applicant: The Regents of the University of California, Oakland, CA (US)

(72) Inventors: Zhaowei Liu, San Diego, CA (US); Junxiao Zhou, San Diego, CA (US); Qianyi Wu, San Diego, CA (US); Junxiang Zhao, San Diego, CA (US)

(21) Appl. No.: 18/839,391

(22) PCT Filed: Feb. 17, 2023
(86) PCT No.: PCT/US2023/062828

§ 371 Date: Aug. 16, 2024

Related U.S. Application Data
(60) Provisional application No. 63/311,766, filed on Feb. 18, 2022.

(51) Int. Cl. G02B 1/00; G02B 21/14; G02B 21/36

(52) U.S. Cl. CPC G02B 1/002; G02B 21/14; G02B 21/365

(57) ABSTRACT

A method, a system, and computer program product for optical systems including a metasurface that supports quantitative phase imaging are provided. Optical system characteristics of an optical system are received. The optical system characteristics include an optical path, the optical system comprising a light source and an imaging system. Optical parameters of at least one metasurface are received. A location of the metasurface is selected within the optical path of the optical system to modulate an incident wavefront generated by the light source. An image acquired by the imaging system is processed, based on the optical parameters of the at least one metasurface and based on the location of the metasurface within the optical path, to determine one or more image properties.

### CROSS-REFERENCE TO RELATED APPLICATIONS

This application is a national stage entry of Patent Cooperation Treaty Application No. PCT/US2023/062828 filed Feb. 17, 2023, entitled “METASURFACE ENABLED QUANTITATIVE PHASE IMAGING,” which claims priority to U.S. Provisional Patent Application No. 63/311,766 filed Feb. 18, 2022, entitled “METASURFACE ENABLED EDGE IMAGING AND QUANTITATIVE PHASE IMAGING,” the disclosures of which are incorporated herein by reference in their entirety.

### TECHNICAL FIELD

This disclosure generally relates to optical systems and, in particular, to optical systems including a metasurface that supports quantitative phase imaging.

### BACKGROUND

Label-free imaging techniques, such as phase-contrast microscopy, and differential interference contrast microscopy, can qualitatively reveal the phase profiles of samples without suffering from phototoxicity, photobleaching, blinking or saturation. A variety of quantitative phase imaging (QPI) techniques can be used to quantitatively characterize weakly absorbing and scattering objects, such as phase-shifting interference microscopes, transport of intensity equation, Fourier ptychography, digital holographic microscopy and diffraction phase microscopy. QPI techniques can be limited in their performance either by multiple sequential measurements, small space-bandwidth product or low phase sensitivity.

### SUMMARY

Methods, systems, and articles of manufacture, including computer program products, are provided for metasurface assisted QPI. In one aspect, a computer-implemented method includes: receiving optical system characteristics of an optical system, the optical system characteristics including an optical path, the optical system including a light source and an imaging system, receiving optical parameters of at least one metasurface, selecting a location of the metasurface within the optical path of the optical system to modulate an incident wavefront generated by the light source, and processing, based on the optical parameters of the at least one metasurface and based on the location of the metasurface within the optical path, an image acquired by the imaging system to determine one or more image properties.

In some variations, one or more features disclosed herein including the following features can optionally be included in any feasible combination. In some implementations, the metasurface includes a plurality of metasurfaces. Each of the plurality of metasurfaces includes a multi-level metasurface attached to an optically transmissive substrate. Selecting the location of the metasurface within the optical path of the optical system includes: positioning the metasurface approximately near a Fourier plan of the optical system. Selecting the location of the metasurface within the optical path of the optical system includes: adjusting the location of the metasurface relative to the optical path or adjusting a position of the imaging system. The imaging system includes a polarized camera, a microscope, or a mobile device. The image includes a differential interference contrast image or a quantitative phase gradient image.

In another aspect, a non-transitory computer-readable storage medium includes programming code, which when executed by at least one data processor, causes operations including: receiving optical system characteristics of an optical system, the optical system characteristics including an optical path, the optical system including a light source and an imaging system, receiving optical parameters of at least one metasurface, selecting a location of the metasurface within the optical path of the optical system to modulate an incident wavefront generated by the light source, and processing, based on the optical parameters of the at least one metasurface and based on the location of the metasurface within the optical path, an image acquired by the imaging system to determine one or more image properties.

In some variations, one or more features disclosed herein including the following features can optionally be included in any feasible combination. In some implementations, the metasurface includes a plurality of metasurfaces. Each of the plurality of metasurfaces includes a multi-level metasurface attached to an optically transmissive substrate. Selecting the location of the metasurface within the optical path of the optical system includes: positioning the metasurface approximately near a Fourier plan of the optical system. Selecting the location of the metasurface within the optical path of the optical system includes: adjusting the location of the metasurface relative to the optical path or adjusting a position of the imaging system. The imaging system includes a polarized camera, a microscope, or a mobile device. The image includes a differential interference contrast image or a quantitative phase gradient image.

In another aspect, a system includes: at least one data processor; and at least one memory storing instructions, which when executed by the at least one data processor, cause operations including: receiving optical system characteristics of an optical system, the optical system characteristics including an optical path, the optical system including a light source and an imaging system, receiving optical parameters of at least one metasurface, selecting a location of the metasurface within the optical path of the optical system to modulate an incident wavefront generated by the light source, and processing, based on the optical parameters of the at least one metasurface and based on the location of the metasurface within the optical path, an image acquired by the imaging system to determine one or more image properties.

In some variations, one or more features disclosed herein including the following features can optionally be included in any feasible combination. In some implementations, the metasurface includes a plurality of metasurfaces. Each of the plurality of metasurfaces includes a multi-level metasurface attached to an optically transmissive substrate. Selecting the location of the metasurface within the optical path of the optical system includes: positioning the metasurface approximately near a Fourier plan of the optical system. Selecting the location of the metasurface within the optical path of the optical system includes: adjusting the location of the metasurface relative to the optical path or adjusting a position of the imaging system. The imaging system includes a polarized camera, a microscope, or a mobile device. The image includes a differential interference contrast image or a quantitative phase gradient image.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that can include one or more processors and one or more memories coupled to the one or more processors. A memory, which can include a non-transitory computer-readable or machine-readable storage medium, can include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to customization of database tables, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIGS. 1A-1C depict diagrams illustrating examples of optical systems, in accordance with some example implementations;

FIGS. 2A and 2B depict examples of metasurfaces, in accordance with some example implementations

FIGS. 2C-2H depict examples of metasurface characteristics, in accordance with some example implementations;

FIGS. 3A-3G depict examples of Fourier optical spin splitting microscopy images, in accordance with some example implementations;

FIGS. 4A-4H depict examples of differential interference contrast (DIC) and of a tissue sample, in accordance with some example implementations;

FIGS. 5A-5H depict examples of DIC and of a fluid sample, in accordance with some example implementations;

FIGS. 6A-6M depict examples of QPI imaging of a tissue sample with a laterally displaced metasurface, in accordance with some example implementations;

FIGS. 7A-7J depict examples of QPI imaging of a tissue sample with a longitudinally displaced metasurface, in accordance with some example implementations;

FIGS. 8A-8G depict examples of quantitative phase gradient imaging (QPGI) imaging with a metasurface, in accordance with some example implementations;

FIGS. 9A-9U show example images captured using an example optical system including a metasurface pair, in accordance with some example implementations;

FIGS. 10A-10O illustrate retardance images and quantitative phase gradient images captured using an example optical system including a metasurface pair, in accordance with some example implementations;

FIG. 11 depicts an example process, in accordance with some example implementations; and

FIG. 12 depicts a diagram illustrating a computing system, in accordance with some example implementations.

When practical, like labels are used to refer to same or similar items in the drawings.

### DETAILED DESCRIPTION

Implementations of the present disclosure are generally directed to optical systems. More particularly, implementations of the present disclosure are directed to optical systems including a metasurface that supports quantitative phase imaging (QPI). QPI provides detailed phase information of the imaged object. To extract phase information, traditional methods use differential interference contrast (DIC) or interferometric microscopy, which involves complex components or critical alignment in the setup. The fundamental principle of QPI is to split or modulate the interference between the object and the reference component, which can be realized by a single polarization-dependent phase modulation device in the Fourier plane instead of complex interferometric setups.

Conventional contrast enhancing imaging methods for transparent samples include phase-contrast and dark field microscopy. The conventional contrast enhancing imaging methods are generally limited to providing qualitative information of the object. Addressing the limitations of conventional contrast enhancing imaging, the technology described herein including QPI based on DIC provides a noninvasive way to quantitatively collect signals that reflect the intrinsic cellular structure. A DIC microscope can perform lateral shearing interferometry on the specimens with a pair of compound birefringent prisms (e.g., Wollaston or Nomarski prisms). The birefringent prisms can separate and recombine the ordinary and extraordinary beams with different directions to produce sheared wave fronts and introduce relative phase retardation. A QPI image of a sample (specimen) can be retrieved by taking multiple DIC frames with different phase retardations. Another QPI imaging technique can be based on interferometric or holographic configuration. The phase information can be acquired by using interference of in-line geometrics in combination with temporal phase shifting, or directly from the shifted Fourier components using off-axis reference geometrics. Traditional QPI techniques can include a bulky setup, critical alignment and multiple images to retrieve the phase information, which limit their applications due to the complexity.

The implementations described herein, provide a phase imaging methodology named Fourier optical spin splitting microscopy (FOSSM), which realizes single-shot quantitative phase gradient imaging based on a dielectric phase metasurface located at the Fourier plane of a microscope. The metasurface separates the object image into two replicas of opposite circularly polarized states with tunable spatially varying phase retardation to generate multiple DIC images of the sample. As FOSSM directly modulate the Fourier space of the microscope without needing complex illumination conditions, it requires no additional optical components and can be easily integrated to existing microscopes. Metasurface based FOSSM can greatly reduce the complexity of current phase microscope setups, enabling high-speed real-time multi-functional microscopy. As another advantage, the described implementations can be configured as label-free phase imaging techniques, providing a noninvasive imaging technology with various applications to biomedical studies.

The implementations described herein, provide Fourier optical spin splitting microscopy (FOSSM), a geometric phase metasurface assisted QPI technology based on the principle of DIC. The metasurface can provide polarization dependent phase modulations to split and modulate the interference between the object and the reference components. In FOSSM, the metasurface can be placed at the Fourier plane of a polarized light microscope such that it divides the object image into two images with opposite circular polarization states and different tilted wave fronts, and generates DIC images with spatially varying phase retardation. Addressing the limitations of traditional DIC, FOSSM directly modulates the Fourier spectrum of the object and allows for the tuning of bias retardation by translation of the metasurface or the rotation of the polarizers. The disclosed mechanism can greatly reduce the complexity of current DIC microscope setups and eliminate the needs for expensive precision optics. Furthermore, single-shot QPGI can be achieved with FOSSM by employing a polarized camera, paving the way for next generation high-speed real-time multi-functional microscopy.

### Examples Results

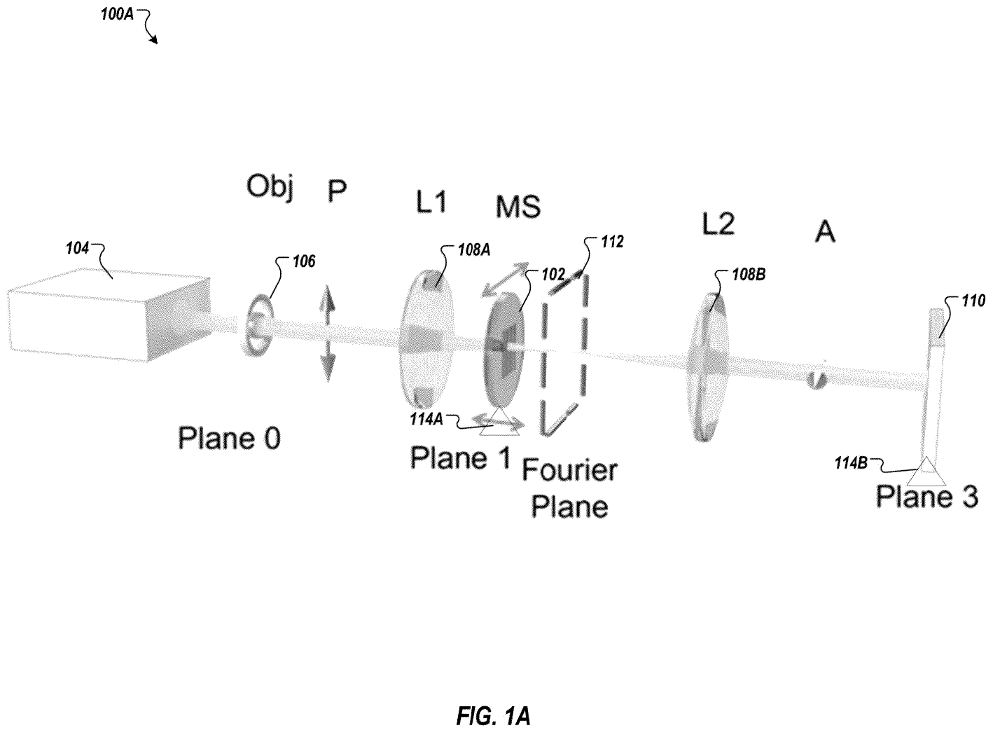

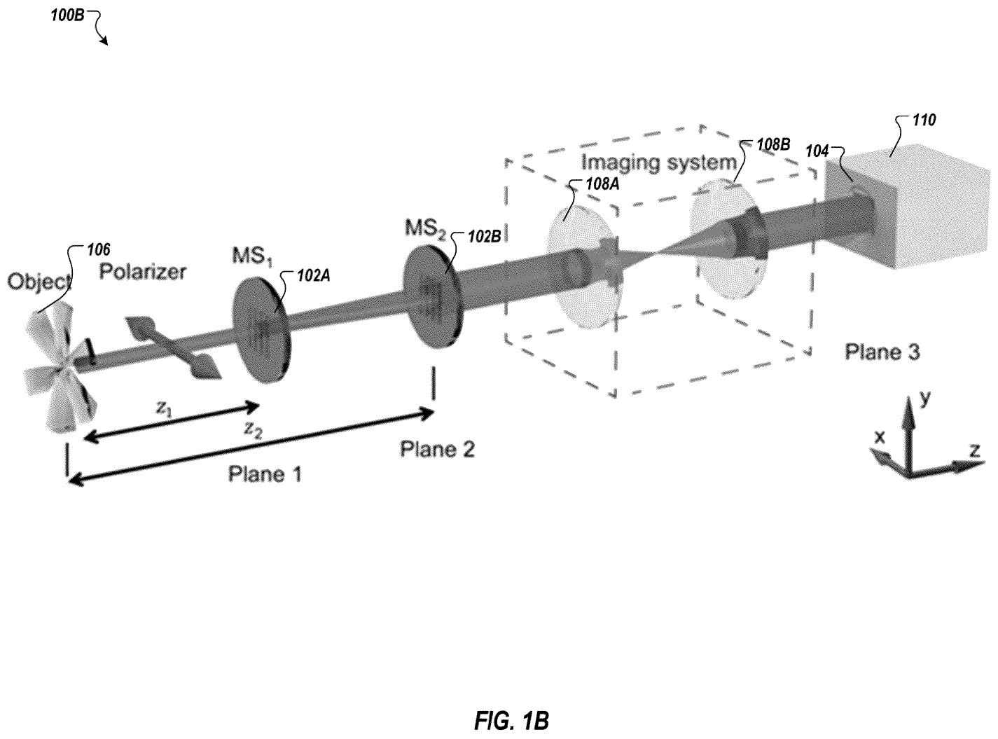

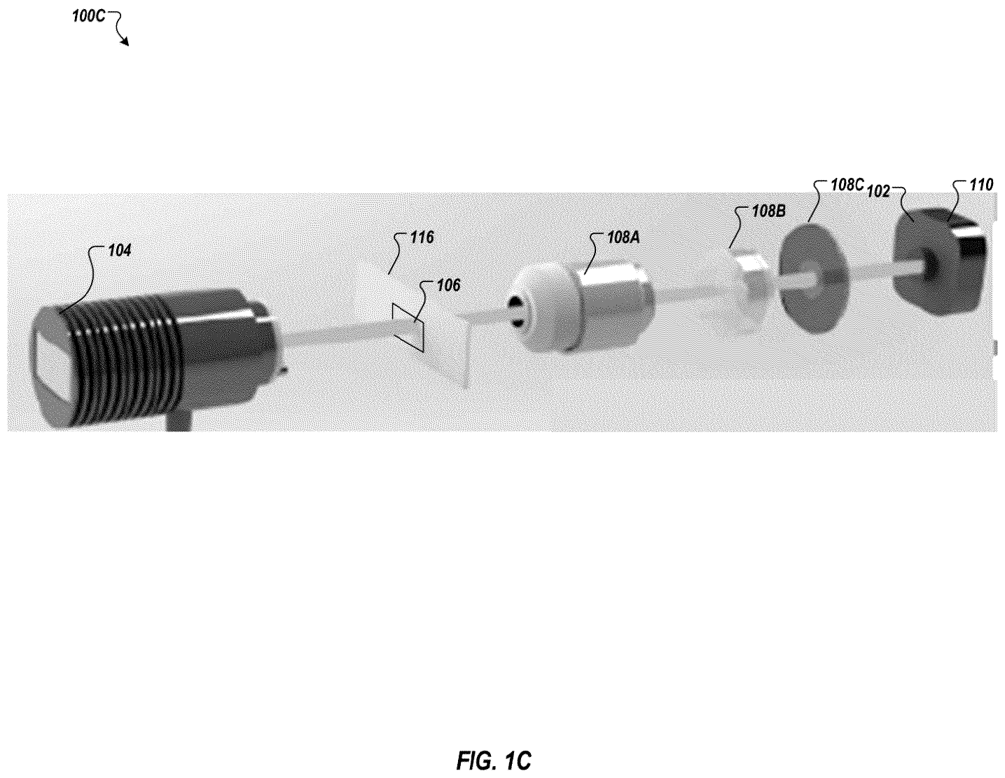

FIG. 1A illustrates an example of an optical system 100A, according to some implementations. The example optical system 100A can be configured to provide FOSSM simultaneous with DIC and based on a metasurface (MS) 102. The example optical system 100A can include the MS 102, a light source 104, an imaging object 106, one or more lenses 108A, 108B, and an imaging device 110.

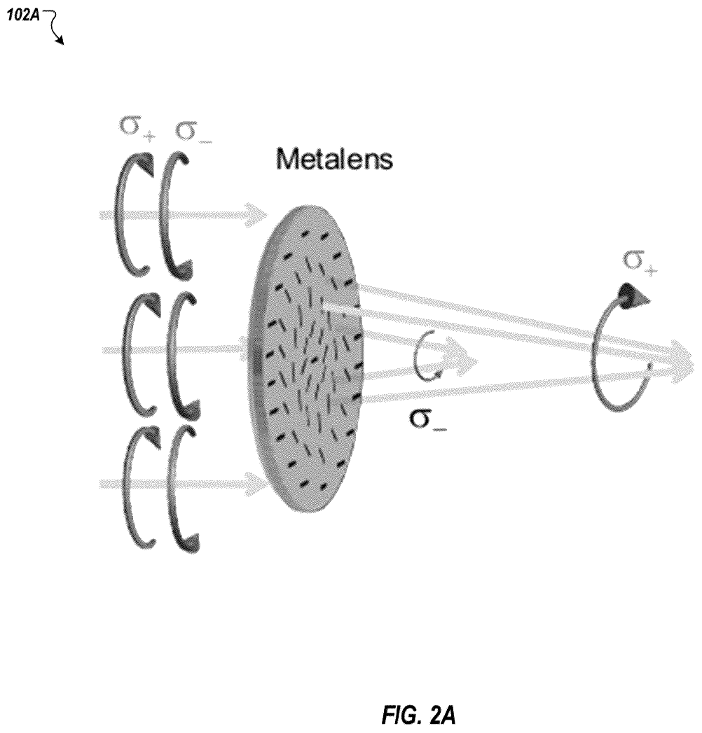

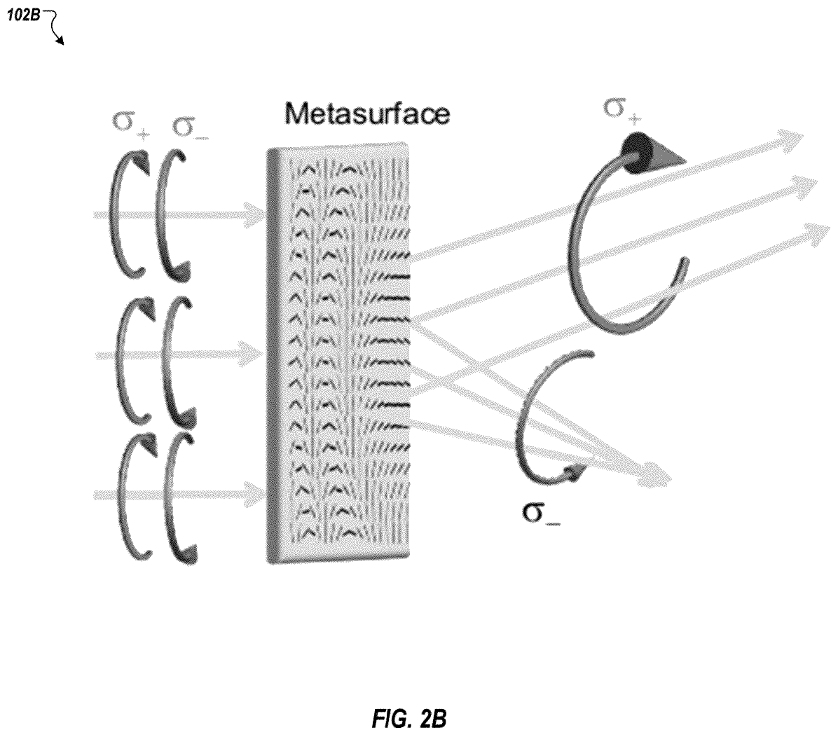

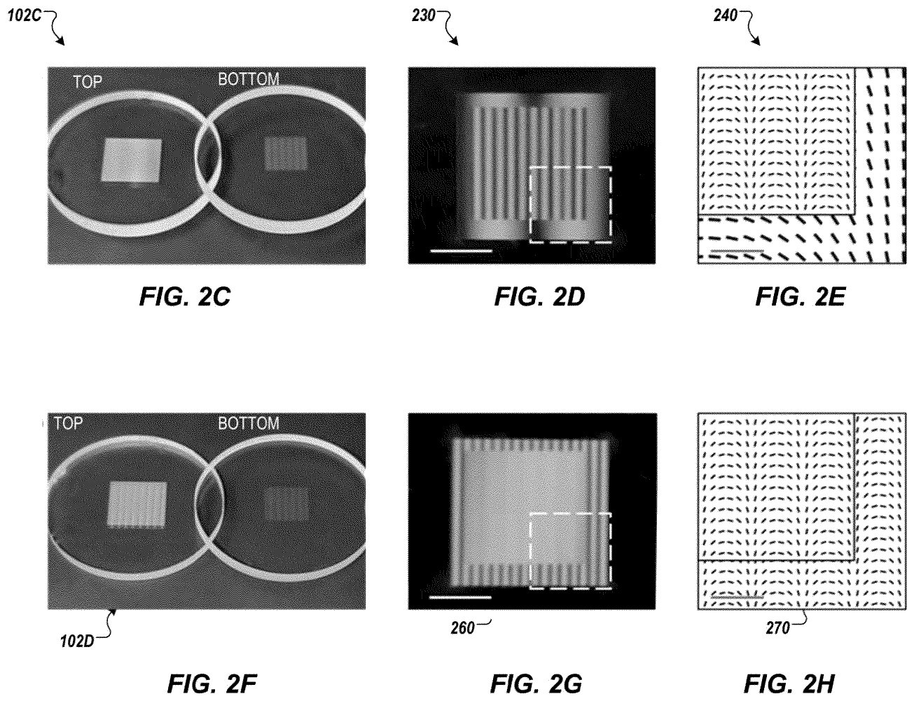

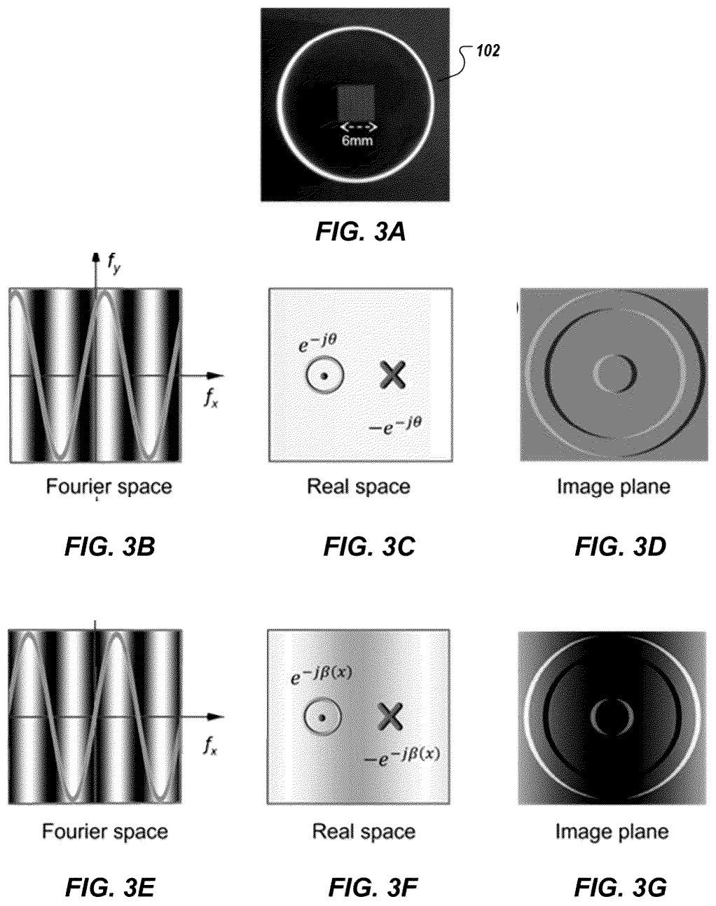

The MS 102 can be an optical component composed of subwavelength-scale meta-atoms to realize wave front modulation by introducing abrupt phase change within a subwavelength thickness. The MS 102 can have a compact and flexible wave front design, such as flat optical lenses, ultrathin holograms, nonlinear optical response enhancement and mathematical operations including spatial differentiation, composition of multiple (e.g., 2 or more) cascaded transmission metasurfaces separated by an optically transparent substrate. The MS 102 can have a circular or a square cross-section, as described with reference to FIGS. 2A-2C. The MS 102 can be a dielectric Pancharatnam-Berry (PB) phase metasurface (see FIG. 3A), which relies on the orientation of the nanostructures to modulate an incident wave front. For example, the diameter of the circular optical support can be 1 inch and the fabricated MS area (included on the front face, a rear face, and/or one or more inner layers of the optical support) can have a 6 mm by 6 mm square geometry.

The light source 104 can be a light emitting diode (LED) or a laser diode. The light source 104 can enable a wavelength and/or a light intensity adjustment. For example, the light source 104 can adjust the intensity of the light supplied to the object, as a function of imaging objectives. The light source 104 can include a halogen lamp, a xenon lamp or some other suitable lamp. The light source 104 can include a reflector, a collimator, and one or more lenses to form a collimated beam for illuminating the imaging object 106.

The imaging object 106 can include a glass plate or container and an imaging target. The imaging target can include a biological sample (tissue or cultured cells including live specimens), pharmaceutical compositions, or other microscopic or submicroscopic structures. The imaging object 106 can be configured to be imaged using a particular light intensity and wavelength without (heat-induced) degradation. The light source 104 can be configured to generate a light beam within a safety range of the imaging object 106, by emitting a light beam with a particular light intensity and wavelength without degrading the imaging object 106.

The lenses 108A, 108B can be concave and/or convex lenses, with different geometries and compositions that can include a wavelength filter. The lenses 108A, 108B can include an objective lens, a tube-lens, an imaging lens, a prism, an eyepiece, an image capturing lens, a collector lens or any other type of lens. The lenses 108A, 108B can be placed on the optical path of the light beam to direct and focus the light beam toward the imaging device 110. In some implementations, the optical beam, after passing the lens 108A can be an unpolarized light beam. The lenses 108A, 108B can be positioned at different locations between the light source 104 and the imaging device 110 to define a location of a Fourier plane 112 in the optical path.

The imaging device 110 can include any type of image capturing device, examination devices and systems that can include, but are not limited to, a camera including an active-pixel sensor, such as a complementary metal oxide semiconductor (CMOS) camera, a charge coupled device (CCD), a smartphone-based camera, a microscope, a ophthalmoscope, pupillometer, fundoscope, stereo imaging device, hyperspectral camera, or a Scheimpflug camera. The imaging device 110 can be configured to capture images of the imaging object 106 that are polarization dependent phase modulated by the MS 102. The MS 102 and/or the imaging device 110 can be attached to a support 114A, 114B, respectively, that can displace the MS 102 and/or the imaging device 110 in any particular direction (e.g., longitudinally along the optical axis or vertically, perpendicular to the optical axis).

As illustrated in FIG. 1A, the MS 102 can be placed approximately near the Fourier plane 112 of the example optical system 100A. A spatially varying orientation of local optical axis

$$φ ( x , y ) = \frac{π x}{Λ}$$

(Λ is the period) is fabricated. The MS 102 can provide additional phases of +2φ and −2φ to incident left-handed circularly polarized (LCP) beams and right-handed circularly polarized (RCP) beams, respectively. The MS 102 can transform unpolarized incident light into opposite helicities. The MS 102 can be sandwiched between a pair of crossed linear polarizers (lenses 108A, 108B), to effectively work as a sinusoidal amplitude grating with a transmittance profile of

$${t}_{ms} ( x , y ) = sin ( \frac{2 π}{Λ} x ) .$$

The MS 102 can modulate the spatial frequencies on the Fourier plane (FP) 112, a spatial differentiator for both amplitude and phase objects is achieved as

$${I}_{out} ( x , y ) \approx {Δ}^{2} {\vert \frac{d {E}_{i n} ( x , y )}{d x} \vert}^{2} ,$$

where Eᵢₙ(x,y) is the electric field of the object and

$$Δ = \frac{λ f}{Λ}$$

is the shearing distance.

The output electric field on the image plane can be the subtraction of the two laterally sheared images with a relative phase retardation, which could be written as:

$${E}_{out}^{′} ( x , y ) = \frac{1}{2} ( {E}_{i n} ( x + Δ , y ) exp [ - j β ( x ) - j θ ] - {E}_{i n} ( x - Δ , y ) exp [ j β ( x ) + jθ ] ) \qquad ( 1 )$$

The spatially varying phase

$$β ( x ) = 2 π \frac{ϵ}{Λ f} x$$

can be resulted from the longitudinal shift ϵ of the MS,

$$θ = 2 π \frac{s}{Λ}$$

represents a bias phase brought by the transverse shift s of the MS 102. The phase retardation between the two replica images can be conveniently tuned by mechanically adjusting the position of the MS 102. For a phase object Eᵢₙ(x,y)=exp[jϕ(x,y)] with unity amplitude, the output intensity can be approximated using the transport-of-intensity (TIE) theory as:

$${I}_{out}^{′} ( x , y ) \approx \frac{1}{2} \{ 1 - cos [ 2 Δ \frac{d ϕ ( x , y )}{d x} - 2 β ( x ) - 2 θ ] \} \qquad ( 2 )$$

Quantitative phase gradient imaging (QPGI) can be realized by taking a series of DIC images with different bias retardation by shifting the MS 102 laterally in the Fourier plane 112. The imaging device 110 can capture three images at

$${s}_{i} = - \frac{1}{6} Λ ( i - 2 ) ( i = 1 , 2 , 3 ) ,$$

the gradient of the phase of the imaging object 106 with respect to x can be calculated via the three-step phase shifting method as:

$${G}_{x} = \frac{d ϕ ( x , y )}{d x} = \frac{1}{2 Δ} atan ( \sqrt{3} \frac{{I}_{1} - {I}_{3}}{2 {I}_{2} - {I}_{1} - {I}_{3}} ) \qquad ( 3 )$$

The intensity can be

$${I}_{i} = 1 - cos ( 2 Δ {G}_{x} - 4 π \frac{{s}_{i}}{Λ} ) , i = 1 , 2 , 3.$$

The phase can be retrieved by integrating the phase gradients with respect to x and y. If the MS 102 is displaced by a distance from the FP 112, the presence of the spatially varying phase β(x) can lead to simultaneous edge detection and high-contrast rendition with shadow-cast pseudo 3D effects of the object within the same FOV. Quantitative phase gradient image of small objects defining the imaging object 106 can be retrieved by capturing multiple (e.g., three or more) images with particular local phase retardations.

If the MS 102 is displaced by a distance from the FP, the presence of the spatially varying phase β(x) leads to simultaneous edge detection and high-contrast rendition with shadow-cast pseudo 3D effects of the object within the same FOV. Quantitative phase gradient image of small objects can be retrieved in the same manner as Eq. 3 by capturing three images with carefully chosen local phase retardations.

FIG. 1B illustrates an example of an optical system 100B, according to some implementations. The example optical system 100B can be configured to provide FOSSM simultaneous with DIC and using multiple (a pair of) metasurfaces (MSs) 102A and 102B. The example optical system 100B can include the MSs 102A, 102B, a light source 104 integrated in an imaging device 110, an imaging object 106, and one or more lenses 108A, 108B.

The MSs 102A, 102B can be based on Pancharatnam-Berry (PB) phase or geometric phase. The MSs 102A, 102B can introduce spin-dependent phases and transform circularly polarized components of the indent light into opposite helicities. The MSs 102A, 102B can be interpreted as half wave plates with designed space-variant optical axes φ(x,y). The influence of the MSs 102A, 102B on the light beams with left-handed circular polarization (LCP) and right-handed circular polarization (RCP) can be described by the Jones matrix using the LCP and RCP bases represented with Dirac bracket notation |L,R [symbol] as

$${T}_{M S} \vert L , R 〉 = [ \begin{matrix}cos 2 φ & sin 2 φ \\ sin 2 φ & - cos 2 φ\end{matrix} ] \vert L , R 〉 = exp ( \pm j 2 φ ) \vert R , L 〉 , \qquad ( 4 )$$

The optical axis distributions of the two MSs 102A, 102B are designed as φᵢ(x,y)=π(x−ξᵢ)/Λᵢ, i=1, 2, where ξᵢ is the transverse shift of MSᵢ along x axis, Λᵢ is the period of MSᵢ.

To illustrate the formation of the image, an x-polarized input beam is assumed and analyzed for determining the propagation of the two circularly polarized components. The MSs 102A, 102B can be placed behind the object with distances z₁ and z₂. In some implementations, the MSs 102A, 102B can be placed near any conjugate plane of the imaging object 106, e.g., in front of the imaging device 110.

The electric field on the object plane can be denoted as Eᵢₙ(x,y). The angular spectrum of the electric field can be calculated with Fourier transform as Fᵢₙ(fₓ,f_{y})= [symbol] [Eᵢₙ(x,y)]. The x-polarized input beam can be composed of equal amounts of LCP and RCP light. With Fresnel approximation, the angular spectrum on Plane 1 for the input LCP or RCP components before MS₁ 102A is related to the input plane as:

$${F}_{1 -}^{L , R} ( {f}_{x} , {f}_{y} ) = {F}_{i n} ( {f}_{x} , {f}_{y} ) exp [ - j π λ {z}_{1} ( {f}_{x}^{2} + {f}_{y}^{2} ) ] \vert L , R 〉 \qquad ( 5 )$$

The angular spectrum right after MS₁ 102A is the convolution of F₁₋^{L,R}(fₓ,f_{y}) with the Fourier transform of the phase profile of MS₁ 102A, using * as the convolution operator, can be expressed as:

$${F}_{1 +}^{L , R} ( {f}_{x} , {f}_{y} ) = {F}_{1 -}^{L , R} ( {f}_{x} , {f}_{y} ) * [ exp ( ∓ j \frac{2 {πξ}_{1}}{{Λ}_{1}} ) δ ( {f}_{x} ∓ \frac{1}{{Λ}_{1}} ) ] \vert R , L 〉 , \qquad ( 6 )$$

The angular spectrum on Plane 2 behind MS₂ 102B is:

$${F}_{2}^{L , R} ( {f}_{x} , {f}_{y} ) = exp [ ∓ j 2 π ( \frac{{ξ}_{1}}{{Λ}_{1}} - \frac{{ξ}_{2}}{{Λ}_{2}} ) ] {F}_{i n} ( {f}_{x} ∓ ( \frac{1}{{Λ}_{1}} - \frac{1}{{Λ}_{2}} ) , {f}_{y} ) exp [ \pm j 2 π λ ( \frac{{z}_{1}}{{Λ}_{1}} - \frac{{z}_{2}}{{Λ}_{2}} ) {f}_{x} ] exp [ - j π λ ( \frac{{z}_{1}}{{Λ}_{1}^{2}} - \frac{2 {z}_{1}}{{Λ}_{1} {Λ}_{2}} + \frac{{z}_{2}}{{Λ}_{2}^{2}} ) ] exp [ - j πλ {z}_{2} ( {f}_{x}^{2} + {f}_{y}^{2} ) ] \vert L , R 〉 . \qquad ( 7 )$$

The phase derivative Gₓ can be approximated by the finite difference, according to Eq. (7). The MSs 102A, 102B can modify the angular spectrum such that the output of the imaging device 110 can be equivalent to the image of the imaging object 106 with electric field as:

$${E}_{i n ; eff}^{L , R} ( x , y ) = exp [ ∓ j 2 π ( \frac{{ξ}_{1}}{{Λ}_{1}} - \frac{{ξ}_{2}}{{Λ}_{2}} ) ] exp [ - j πλ ( \frac{{z}_{1}}{{Λ}_{1}^{2}} - \frac{2 {z}_{1}}{{Λ}_{1} {Λ}_{2}} + \frac{{z}_{2}}{{Λ}_{2}^{2}} ) ] {E}_{i n} ( x \pm [ λ ( \frac{{z}_{1}}{{Λ}_{1}} - \frac{{z}_{2}}{{Λ}_{2}} ) ] , y ) exp [ \pm j 2 π ( \frac{1}{{Λ}_{1}} - \frac{1}{{Λ}_{2}} ) x ] \vert L , R 〉 \qquad ( 8 )$$

The imaging system including lenses 108A, 108B can have a magnification of unity. The output electric field on Plane 3 can be the projection of the LCP and RCP components onto the polarization orientation Θ of the analyzer, which can be the sum of two laterally displaced images with different phase retardations

$${E}_{3} ( {x}_{3} , {y}_{3} ) = C \{ {E}_{i n} ( {x}_{3} - Δ , {y}_{3} ) exp [ j ( κ ( {x}_{3} ) + ψ - Θ ) ] + {E}_{i n} ( {x}_{3} + Δ , {y}_{3} ) exp [ - j ( κ ( {x}_{3} ) + ψ - Θ ) ] \} , \qquad ( 9 )$$

The term C can be a constant phase term, Δ=λz₂/Λ₂−λz₁/Λ₁ is the lateral displacement. The term κ(x)=2π(1/Λ₁−1/Λ₂)x is a space-variant phase resulted from the period difference of the two MSs 102A, 102B. The term

$$ψ = 2 π ( \frac{{ξ}_{1}}{{Λ}_{1}} - \frac{{ξ}_{2}}{{Λ}_{2}} )$$

is a biased phase.

For the special case of two MSs 102A, 102B with an identical period Λ, MS₂ 102B can perfectly cancel the opposite tilted phases of LCP and RLP gained from MS₁ 102A respectively, which leads to an output intensity as:

$${I}_{out} ( {x}_{3} , {y}_{3} , 2 {θ}^{′} ) ∼ {\vert {E}_{i n} ( {x}_{3} - {Δ}_{0} , {y}_{3} ) exp ( j {θ}^{′} ) + {E}_{i n} ( {x}_{3} + {Δ}_{0} , {y}_{3} ) exp ( - j {θ}^{′} ) \vert}^{2} , \qquad ( 10 )$$

In equation (10):

$${Δ}_{0} = \frac{λ d}{Λ} , {θ}^{′} = \frac{2 πΔξ}{Λ} - Θ ,$$

d=z₂−z₁, Δξ=ξ₁−ξ₂. The output intensity can have the same mathematical form as the differential interference contrast image. The lateral displacement Δ₀ can be tuned by changing the distance d along the z axis between the two metasurfaces while the bias retardation 0′ is related to the relative positions Δξ of the MSs 102A, 102B along the x axis and the polarization orientation of the analyzer.

For a complex object Eᵢₙ(x,y)=A(x,y) exp[jϕ(x,y)], the intensity to be captured at the image plane is given by the transport-of-intensity (TIE) equation:

$${I}_{out} ( {x}_{3} , {y}_{3} , 2 {θ}^{′} ) - {A}^{2} ( {x}_{3} - {Δ}_{0} , {y}_{3} ) + {A}^{2} ( {x}_{3} + {Δ}_{0} , {y}_{3} ) + 2 A ( {x}_{3} - {Δ}_{0} , {y}_{3} ) A ( {x}_{3} + {Δ}_{0} , {y}_{3} ) cos [ ϕ ( {x}_{3} - {Δ}_{0} , {y}_{3} ) - ϕ ( {x}_{3} + {Δ}_{0} , {y}_{3} ) + 2 {θ}^{′} ] . \qquad ( 11 )$$

The imaging device 110 can include a polarized camera with interlaced micro-polarizers of orientation. By utilizing a polarized camera with interlaced micro-polarizers of orientation αᵢ=(i−1)×π/4 and de-interspersing the captured image into 4 parts, four retardance images Iᵢ=Iₒᵤₜ(x₃,y₃,(i−1)×π/2) can be obtained in a single shot (assume Δξ=0). When the lateral displacement Δ₀ is small, the unidirectional phase gradient and amplitude of the object can be approximated by

$${G}_{x} \approx \frac{1}{2 Δ} [ ϕ ( {x}_{3} + Δ , {y}_{3} ) - ϕ ( {x}_{3} - Δ , {y}_{3} ) ] = \frac{1}{2 Δ} atan ( \frac{{I}_{2} - {I}_{4}}{{I}_{1} - {I}_{3}} ) . \qquad ( 12 )$$

$$A ( {x}_{3} , {y}_{3} ) \approx \sqrt{A ( {x}_{3} - Δ , {y}_{3} ) A ( {x}_{3} + Δ , {y}_{3} )} = \sqrt{\frac{\vert {I}_{1} - {I}_{3} \vert + \vert {I}_{4} - {I}_{2} \vert}{4 ( \vert cos 2 Δ {G}_{x} \vert + \vert sin 2 Δ {G}_{x} \vert )}} . \qquad ( 13 )$$

To solve the optimization problem, the alternating direction method of multipliers (ADMM) can be used to reconstruct the phase from the unidirectional phase gradient, which consists of the following updates at the k^{th} iteration.

$${ϕ}^{( k + 1 )} ← iDST [ \frac{{r}^{( k )} {k}_{y}^{2} - {k}_{x}^{2} D S T ( {\partial }_{x} {G}_{x} ) - ρ {k}_{y}^{2} D S T ( {v}^{( k )} )}{{k}_{x}^{4} + ρ {k}_{y}^{4} + ϵ} ]$$

$${v}^{( k + 1 )} ← {S}_{\frac{μ}{ρ}} ( \frac{{r}^{( k )}}{ρ} + {\partial }_{y}^{2} {ϕ}^{( k + 1 )} )$$

$${r}^{( k + 1 )} ← {r}^{( k )} + ρ ( {v}^{( k + 1 )} - {\partial }_{y}^{2} {ϕ}^{( k + 1 )} )$$

The terms DST and iDST are the discrete sine transform and inverse discrete sine transform, r is the Lagrange multiplier, ρ is the penalty parameter, ϵ is a small value to guarantee numerical stability, S_{α} is the soft thresholding operator with a threshold value of α:

$${S}_{α} ( ξ ) = \{ \begin{matrix}ξ - α & ξ > α \\ 0 & \vert ξ \vert \leq α \\ ξ + α & ξ < - α\end{matrix} .$$

The imaging object 106 can include a glass coverslip that was sonicated in acetone and rinsed with isopropanol and water as substrate. The imaging object 106 can include a PMMA solution that was made with 30 mg/ml concentration in toluene. PMMA solution was spin-coated on the cleaned coverslip at 4000 rpm for 30 s. The sample can be placed on a 200° C. hot plate for 7 minutes to form a thin PMMA film. The sample can be covered by tape which has several pinholes on it. After O₂ plasma etching with 5 sccm gas flow and 200 W forward RF power for 5 minutes, the PMMA film under the pinholes is etched off, which forms the phase object. The sample can be used for imaging after peeling off the protecting tape.

FIG. 1C illustrates an example of an optical system 100C, according to some implementations. The example optical system 100C can be configured to provide FOSSM simultaneous with DIC and based on one or more MSs 102 attached to an imaging device 110. The example optical system 100C can include a light source 104, an imaging object 106, one or more lenses 108A, 108B, 108C, and the imaging device 110. The light source 104, the imaging object 106, the lenses 108A, 108B, 108C, and the imaging device 110 can include any of the components and features described with reference to FIG. 1A. In some implementations, as illustrated in FIG. 1C, the light source 104 can include a LER light source. The imaging object 106 can be attached to a sample holder 116. The lens 108A can include an objective lens. The lens 108B can include a tube lens. The imaging device can include a CCD device.

FIGS. 2A-2C illustrate examples of MSs 102A, 102B, 120C. FIG. 2A shows a circular MS 102A that can be used in an optical system (e.g., optical system 102A, 102B, 102C described with reference to FIGS. 1A-1C). The example MS 102A can be used in an optical system for QPI. The example MS 102A can include a geometric phase lens integrated into one single dynamic phase lens. For example, the MS 102A can include a geometric phase metasurface that is fabricated onto a conventional lens, such that MS 102A can enable quantitative phase imaging by itself without requiring any other optical components. As another example, the MS 102A can be fabricated on a transparent substrate (e.g., a piece of glass) and inserted into an existing optical system (e.g., optical system 102A, 102B, 102C described with reference to FIGS. 1A-1C). The geometric phase metasurface can be designed to provide additional focusing phase based on different polarization states of the light.

A linearly polarized light incident to an imaging object can pass the MS 102A, resulting in a light beam including separated left handed circularly polarized (LCP) and right handed circularly polarized (RCP) components along the propagation direction and imaged at the different positions with tiny focal length difference. For example, using a linear polarized illumination, the MS 102A can separate the linear polarized object light into a LCP component and a RCP component, each with a different focusing phase such that their images are focused on slightly different positions along the optical axis. The generated beam can be captured by an imaging device (e.g., a polarized camera). The imaging device can generate LCP and RCP images that can be captured simultaneously. Multiple images of the two slightly defocused components can be acquired from a single measurement to extract the quantitative phase information of the imaging object. The LCP and RCP images can be processed to determine the intensity derivative that is used for the quantitative phase extraction based on transport-of-intensity (TIE) equation theory, as described with reference to FIGS. 1A and 1B. The MS 102A can be an ultracompact, portable metalens (lens with integrated metasurfaces) including polarization-dependent features.

FIG. 2B shows a rectangular MS 102B that can be used in an optical system (e.g., optical system 102A, 102B, 102C described with reference to FIGS. 1A-1C). The example MS 102B can be used in an optical system for QPI. The example MS 102B can be used to introduce a conjugated phase to the LCP and RCP. The example MS 102B can display different focal powers to the two polarizations. The example MS 102B inserted in an optical system, can slightly shift the focal planes of the LCP and RCP images in opposite directions, such that when RCP is in focus, the LCP is out of focus. Using TIE QPI equation theory, as described with reference to FIGS. 1A and 1B, the LCP and RCP images can be separated on the image plane. A linear phase can be added to the metasurface. The example MS 102B can enable QPI using typical microscopes with incoherent illumination. The example MS 102B can be included in an optical system to achieve quantitative phase imaging in a single measurement. The example MS 102B can be used without a specific optical alignment and can be inserted in any position of an optical system between the imaging object and the imaging device, including attached to the imaging device. The example MS 102B can separate the incident object light into its LCP and RCP components with opposite phase gradient. The two replica images can be formed at different locations on the imaging device. The example MS 102B can provide additional opposite focusing phase to the LCP and RCP components that can shift the focal planes of the LCP and RCP images in opposite directions along the optical axis. As the two replica images are spatially separated, no special detector is required other than a regular camera. A TIE based image reconstruction method can be used to retrieve the phase information of the object from the two slightly blurred images captured by the camera.

FIGS. 2C-2H illustrate example characteristics of metasurfaces embedded in a support structure (e.g., silica glass). For example MS 102C, 102D can include dielectric metasurfaces fabricated by using a laser writing method. FIGS. 2C and 2F show photographs of top views (left) and bottom views (right) of the metasurface pairs with periods of 8 mm, 1 mm and identical periods of 1 mm, respectively. The MS pairs 102C, 102D can be fabricated inside the bulk SiO₂ substrates 80 μm away from the top surfaces. In response to an intense femtosecond pulse laser beam illuminating the substrate, the SiO₂ can partially decompose into porous glass SiO₂₋ₓ with its refractive index determined by the laser intensity. The combination of the two media results in a local birefringence of the written pattern. By rotating and/or translating the substrate of the MS pairs 102C, 102D, spatially varying birefringence nanostructures can be induced, having an optical axis orientation dependent on the incident laser polarization. The writing depth can be uniformly designed such that the MS pairs 102C, 102D works as a half wave-plate with space-variant optical axis to generate a highly efficient phase modulation.

The polariscopic optical characterization images can be employed to characterize the generated space-variant birefringence patterns of two stacked MS pairs 102C, 102D, as shown in FIGS. 2D and 2G. The periods of the sinusoidal patterns formed in the overlapped regions can be determined by the difference of the periods of the metasurface pair, according to the definition of the space-variant phase κ(x). The two metasurfaces forming the MS pairs 102C, 102D including identical periods, as shown in FIG. 2G, can cancel the linear geometric phase of each other and yield a uniform transmission in the overlapped region. FIGS. 2E and 2H illustrate the orientations of the nanostructures of the two overlaid metasurfaces in the white dashed boxes in FIGS. 2D and 2G.

Using MS pairs 102C, 102D, the field of view (FOV) of the proposed imaging system can correspond to the size of the patterned area of the metasurfaces as well as the FOV of the imaging system (e.g., microscope). The resolution of the reconstructed quantitative phase images can depend on the numerical aperture (NA) of the objective and the lateral displacement Δ between the two replicas, which can be determined by the periods of the metasurfaces and the distance between them. A smaller displacement Δ results in better resolved phase reconstruction since a smaller Δ causes less blurring of the reconstructed field along the shearing direction. To enhance the resolution, a small Δ. An appropriately chosen Δ can be used to maintain a targeted resolution to noise ratio during measurements.

A single-shot QAPI method can be based on a pair of all-dielectric metasurfaces placed near any conjugate plane of the object. An advantage of using the MS pairs 102C, 102D is the flexibility to place the MS pairs 102C, 102D without modifying existing optical systems. The retardance images can be formed if the MS pairs 102C, 102D are placed within close proximity of any conjugate plane of the object, e.g., in front of the image sensor or right beneath the specimen, for example, outside the Fourier plane. The MS pairs 102C, 102D can be miniaturized to a monolithic bilayer metasurface that can be configured to be attached to a front lens of an imaging device. Directly writing the metasurface patterns into glass slides or petri dishes that hold specimens for examination provides another straightforward and user-friendly implementation for QAPI. In addition, optical diffraction tomography can be combined with the metasurfaces-assisted QAPI system to generate a 3D volumetric refractive index of samples by scanning the illumination angles.

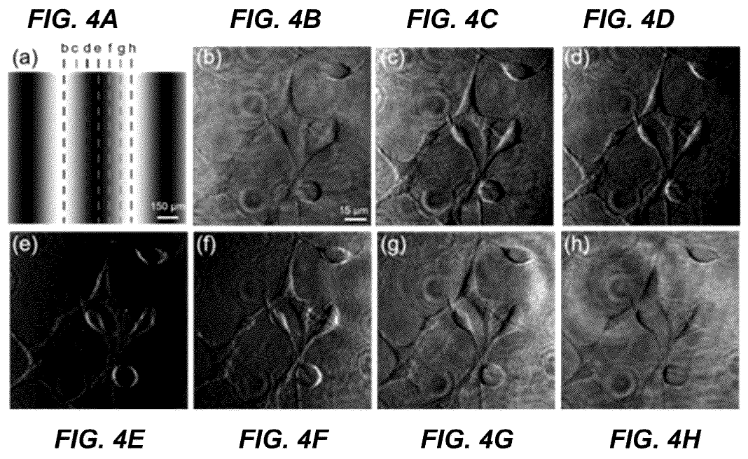

FIGS. 3A-4G illustrate example experimental implementations of the example system described with reference to FIG. 1A. FIG. 3A illustrates an example of a MS (e.g., MS 102 described with reference to FIG. 1A) including a circular support for an MS square shaped region. FIGS. 3B-3G illustrate the outcome of MS translation during image capture. As shown in FIGS. 3B-3D, if the MS 102 presents a transverse shift s of along x axis, the uniform phase retardation between the LCP and RCP components changes. As shown in FIGS. 3E-3G, a longitudinal shift ϵ along z axis of the MS 102 can result in simultaneous angular and spatial shift of the angular spectrum of the object. The sinusoidal lines in FIGS. 3B and 3E represent line profiles of the transmittance along fₓ direction. FIGS, 3C and 3F show that the impulse response of the optical system is two shifted delta functions with conjugate phases. FIGS. 3D and 3G show the output image of a phase object when the MS is shifted along x direction and z direction, respectively.

FIGS. 4A-4H include example images captured using the example system described with reference to FIG. 1A. The imaging object used to generate the images illustrated by FIGS. 4A-4H included human embryonic kidney 293. FIGS. 4A-4H demonstrate the continuous tunability of the bias retardation in the DIC images using FOSSM, a fixed imaging object (HEK 293 cells) while translating the MS in the lateral direction. FIG. 4A shows the effective transmission of the MS 102 at the back aperture of the microscope. FIGS. 4B-H correspond to the dashed lines from b to h in FIG. 4A, which indicate the relative position of the MS with respect to the optical axis of the imaging device. As is shown in FIGS. 4B-E, the local phase difference between the two replicates gradually increases and reaches π in (FIG. 4E), of which the image contrast reaches the maximum. The maximum image contrast can the condition for edge imaging. As the MS is continuously shifted, the phase difference continuously increases and causes reversed image contrast, as indicated in FIGS. 4E-H.

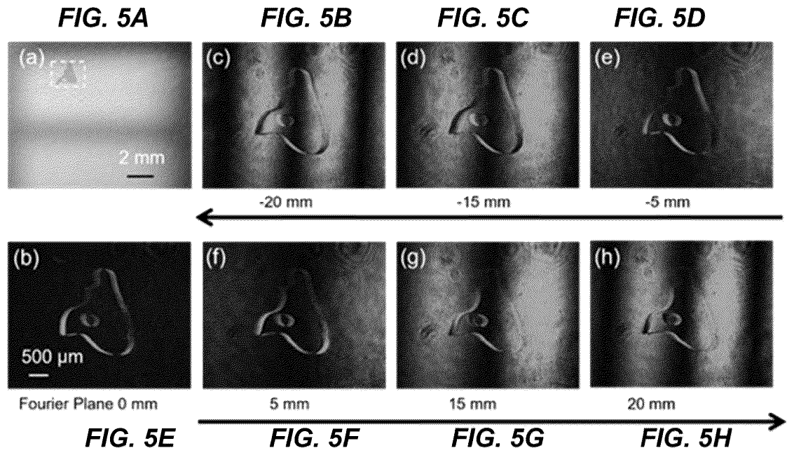

FIGS. 5A-5H include example images captured using the example system described with reference to FIG. 1A. FIGS. 5A-5H show the blending of DIC with continuously varying bias retardations as we move the MS 102 away from the Fourier plane of the microscope. A phase object can be imaged by FOSSM with the MS centered at the optical axis (s=0) at the Fourier plane. Different frames can be captured, by the imaging device, when the MS is moved away from the Fourier plane along the optical axis while maintained centered in the x-y plane. FIG. 5B shows an example of regular edge detection imaging captured when the MS is approximately at (less than 1 mm away from) the Fourier plane (s=0, ϵ=0). FIGS. 5C-5H illustrate examples of images captured when the MS moves along the z-axis in either direction. As shown in FIGS. 5C-5H, the spatially varying phases of the two sheared replicas form a sinusoidal background over the imaging area, which indicates a spatially dependent DIC phase retardation. The regions with bright peaks in the images of FIGS. 5B-5D and 5F-5H show the interference patterns that correspond to zero phase retardation, which leads to image addition. The regions with dark valleys of the interference patterns in the images of FIGS. 5B-5D and 5F-5H correspond to a π phase retardation which leads to edge detection. The size of the imaging regions varies with respect to the distance e between the MS and the Fourier plane according to Eq. 2, as described with reference to FIG. 1A.

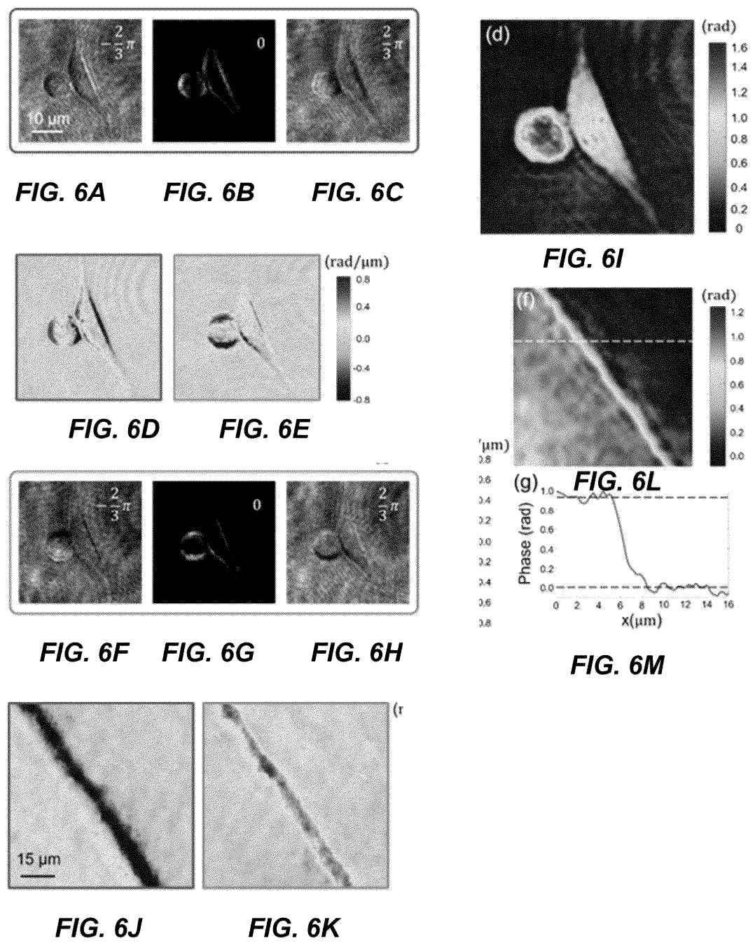

FIGS. 6A-6K include example images captured using the example system described with reference to FIG. 1A. FIGS. 6A-6K show the quantitative phase imaging capability of FOSSM. The imaging object used to generate the example images shown in FIGS. 6A-6K included NIH3T3 cells. The imaging object was in a fixed location within the optical path. The imaging object (NIH3T3 cells) was imaged with the MS placed substantially at the Fourier plane (ϵ=0). FIGS. 6A-6C and 6F-6H show images with phase retardations of −120°, 0°, 120° taken for both horizontal and vertical directions using a scale bar of 10 μm. FIGS. 6D-6E show the phase gradients of the imaging object for both directions as can be calculated with Eq. 3, as described with reference to FIG. 1A. The quantitative phase image of the object can be calculated by the 2D integration of the phase gradient images, as shown in FIG. 6I. To verify the extracted phase, a thin polymethyl methacrylate (PMMA) film with thickness of 160 nm was used as a calibration sample and was imaged using the same optical system (e.g., optical system 100A described with reference to FIG. 1A). The extracted phase difference between regions with and without the PMMA thin film is 0.95 radian, matching the determined film thickness as shown in FIGS. 6L and 6M (FIG. 6M showing a cross-section along the dashed line in FIG. 6L). The theoretical phase difference can be calculated based on the corresponding refractive indexes and the working wavelength, as:

$$( \frac{{n}_{P M M A} - {n}_{a i r}}{λ} ) \times {t}_{P M M A} \times 2 π .$$

The refractive index n_{PMMA} is 1.4934, nₐᵢᵣ is 1 and λ=532 nm is the working wavelength.

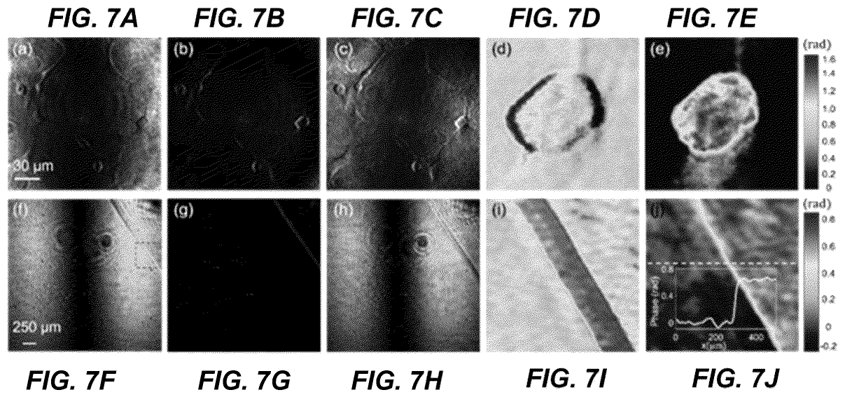

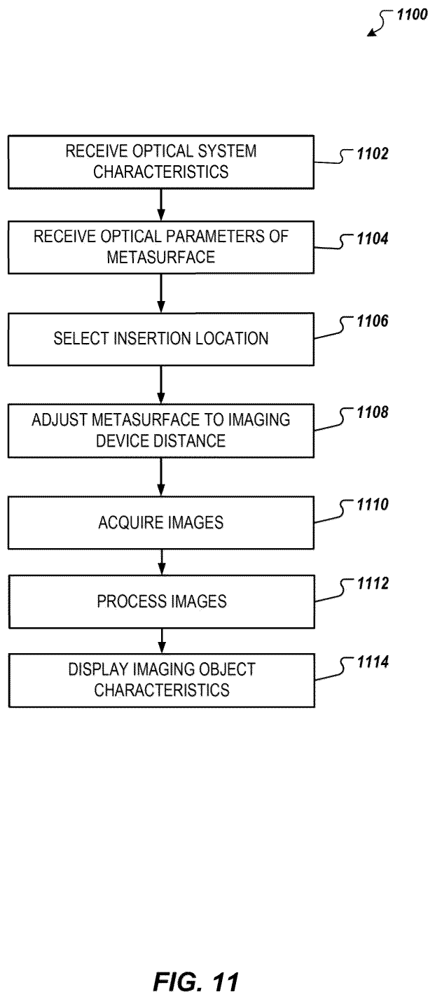

FIGS. 7A-7J include example images captured using the example system described with reference to FIG. 1A. FIGS. 7A-7J show quantitative phase imaging capability when the MS can be moved away from the Fourier plane. The imaging object used to generate the example images shown in FIGS. 7A-7J included NIH3T3 cells. FIGS. 7A-7C show DIC images taken such that the boxed region has a local phase retardation around −120°, 0°, 120°. FIG. 7D shows the phase gradient image of the cell within the boxed region. FIG. 7E shows the retrieved QPI image of the NIH3T3 cell. FIGS. 7F-7H show DIC images of the PMMA calibration sample. FIG. 7I shows the phase gradient image of the edge of the 110-nm-thick PMMA thin film. FIG. 7J shows the QPI image of the PMMA sample with an overlapping cross section of the QPI along the dashed line. Within a neighborhood of the area of interest, the spatially varying phase exp (−jβ(x)) can be estimated pixel-wise by analyzing the sinusoidal background. Three images with well separated phase retardations were taken, while the MS was translated along the optical axis, to reconstruct the phase gradient image with a generalized phase-stepping algorithm (further described with reference to FIG. 11). The extracted phase, corresponding to a thickness of 110 nm shown in FIG. 7J matches the measured film thickness, indicating the accuracy at quantitative imaging of the NIH3T3 cell shown in FIG. 7E.

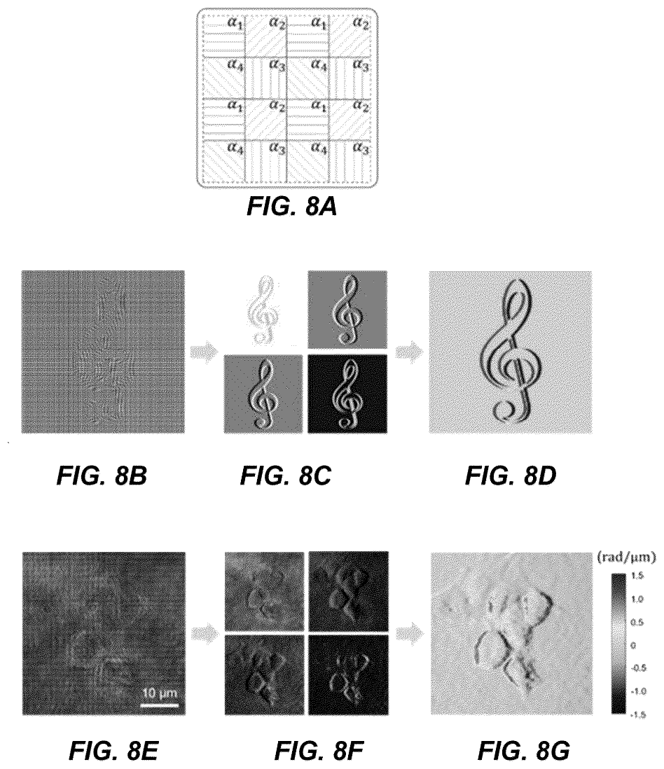

FIGS. 8A-8G include example images captured using the example system described with reference to FIG. 1A. FIGS. 8A-8G show FOSSM modified to perform single-shot QPGI. The imaging object used to generate the example images shown in FIGS. 8A-8G included NIH3T3 cells. The imaging device used to generate the images shown in FIGS. 8A-8G included a CMOS camera. FIG. 8A illustrates the polarization orientation for each pixel on the camera. FIG. 8B shows the simulation of single shot QPGI. FIG. 8C shows a single shot QPGI of NIH3T3 cells. The interlaced pixels from the polarization camera are rearranged into four subframes corresponding to DIC images with 0°, 90°, 180° and 270° phase retardations. The corresponding QPGI can be retrieved using the four-step phase shifting method. The effective transmittance of the metasurface tₘₛ(x,y) can be translated along the phase gradient direction by adjusting the orientation of the analyzer. The imaging system used to generate FIGS. 8B-8G can contain interspersed polarized pixels for 0°, 45°, 90° and 135° polarization orientation, four sub-frames of DIC images with phase retardation of 0°, 90°, 180° and 270° can be captured with only one measurement. FIGS. 8C and 8F show four DIC images of different phase retardations that can be clearly distinguished after rearranging the interlaced pixels from the polarization camera. The phase gradient information of the object can be retrieved by using the four-step phase shifting method.

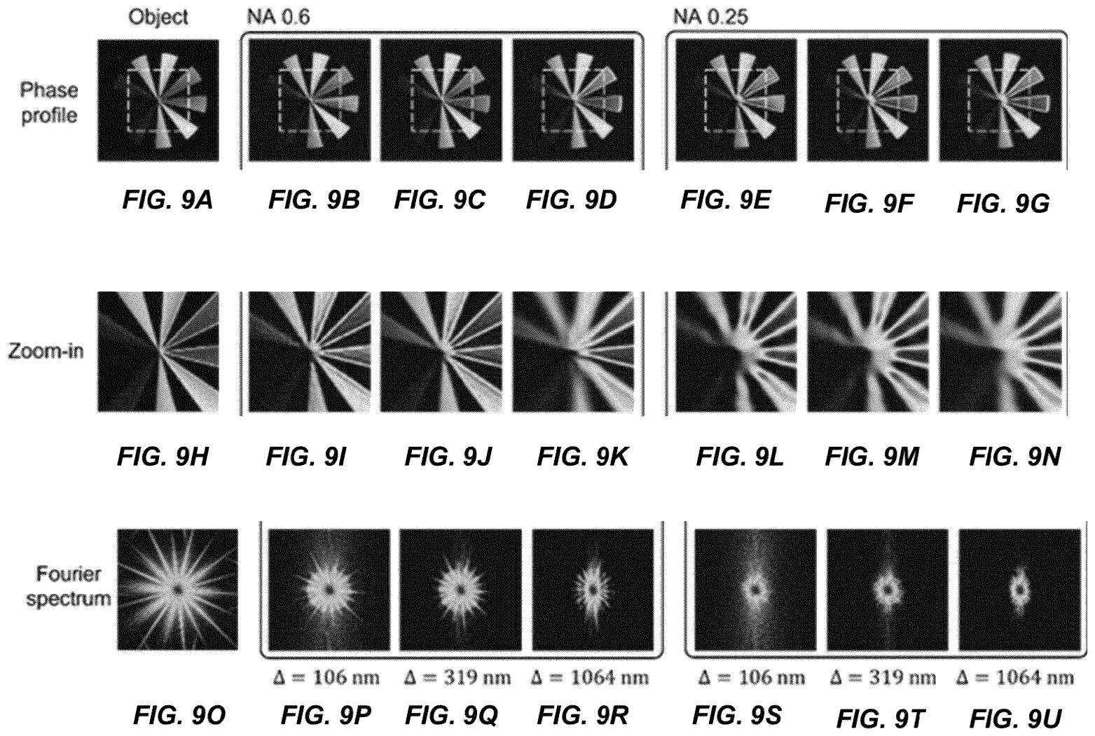

FIGS. 9A-9U include example phase profile, zoom-in, and Fourier spectrum images captured using the example optical system described with reference to FIG. 1B. FIGS. 9A-9U show numerical investigation of the error mechanisms in phase reconstruction. The phase profiles shown by FIGS. 9A-9G are reconstructed from measurements with an objective of NA 0.6 or 0.25 given different lateral displacements Δ=106, 319 and 1064 nm, respectively. 15 dB Poisson noise is added to the measurements. The zoom-in images shown by FIGS. 9H-9N correspond to the central region in the white dashed boxes of the phase profiles of FIGS. 9A-9G. The Fourier transforms of the reconstruction are shown in FIGS. 9O-9U for better comparison of the resolution. FIGS. 9A-9U show that the signal-to-noise ratio (SNR) of the measurements is 15 dB. A small devition Δ (Δ=106 nm) can results in a small numerator in the finite difference, making the phase recovery less robust to the noise in the measurements. If the devition Δ is large (Δ=1064 nm), the first order finite difference approximation breaks down and lead to a blurred reconstruction with reduced resolution along the shearing direction. The resolution undermining effect can be more obvious when employing a larger NA objective. A moderate Δ (Δ=319 nm) can keep the robustness of the phase recovery without sacrificing the resolution too much.

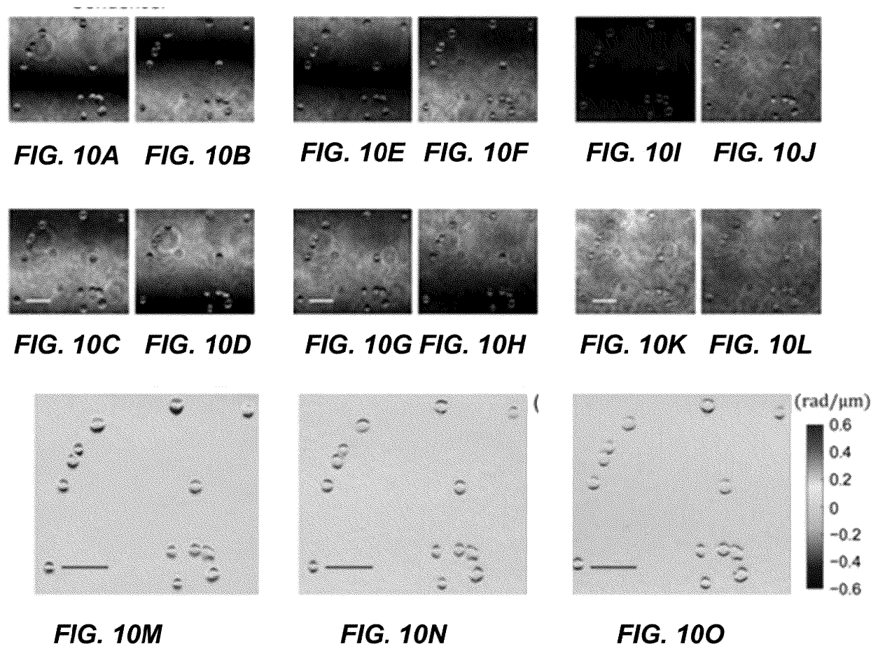

FIGS. 10A-10O illustrate retardance images and quantitative phase gradient images of SKNO-1 cells obtained using an optical system (e.g., optical system 100B, 100C described with reference to FIGS. 1B and 1C) including a metasurface pair of various combination of periods as described with reference to FIGS. 2C-2H. The two metasurfaces MS₁ and MS₂ can be centrally aligned and placed at distances of z₁=3.6 mm and z₂=7 mm with respect to the object, respectively. Fixed acute myeloid leukemia cells (SKNO-1) can be illuminated with a 532 nm laser and imaged with a polarization CMOS camera (BFS-U3-51S5P-C, IMX250MZR, FLIR) which contains interspersed polarized pixels with 0°, 45°, 90° and 135° polarization orientations. Four sub-frames of retardance images with a sequential phase retardation interval of 90° can be obtained by de-interspersing a single shot captured with the polarized camera.

FIGS. 10A-10L illustrate simultaneously obtained four retardance images with different phase delays given various metasurface pair configurations. For example, the retardance images shown in FIGS. 10A-10D can correspond to metasurfaces including periods Λ₁=+∞ mm (no MS₁), Λ₂=1 mm. The retardance images shown in FIGS. 10E-10H can correspond to metasurfaces including periods Λ₁=8 mm, Λ₂=1 mm. retardance images shown in FIGS. 10I-10L can correspond to metasurfaces including periods Λ₁=1 mm, Λ₂=1 mm. In the first two cases, since the two metasurfaces have different periods, their mismatching phase profiles form a non-uniform sinusoidal background, which indicates a spatially dependent phase retardation in the output images. The bright peaks of the fringe patterns correspond to a zero-phase retardation which leads to constructive addition, while the dark valleys are associated with a π phase retardation which results in destructive interference. Determined by the difference of Λ₁ and Λ₂, the frequencies of the periodic sinusoidal background gradually decrease as is shown in FIGS. 10A-10L. The frequency can reach zero in FIGS. 10I-10L when MS₂ perfectly cancels the phase gradient from MS₁, where retardance images with uniform bias retardations controlled by the polarization orientation of the analyzer can be obtained.

FIGS. 10M-10O illustrate calculated QPGI images of the cells by processing the images from FIGS. 10A-10D, FIGS. 10E-10H, and 10I-10L with a generalized phase-stepping algorithm, using scale bars, 50 μm. The lateral displacements Δ of the two replicas can be related to the periods of the two metasurfaces and are measured to be 3.7 μm, 3.5 μm and 1.9 μm in 10M-10O, respectively. With two identical metasurfaces, retardance images with spatially constant bias retardations can be obtained, which are easier to interpret and require a simpler calculation for the phase gradient. The lateral displacement can be decoupled from the absolute positions of the two metasurfaces with respect to the object and only related to the relative distance d between them. If d is fixed, the position of the metasurface pair does not change the lateral displacement Δ₀, which can be designed to be optimal for the phase reconstruction. FIGS. 10A-10O demonstrate the tunable phase retardation in the retardance images captured by a polarized camera when various metasurface pairs are applied.

FIG. 11 depicts a flowchart illustrating an example process 1100 for quantitative imaging using an optical system including a metasurface, in accordance with some example implementations. The example process 1100 can be executed by the optical system 100A, 100B, 100C shown in FIGS. 1A-1C, using a metasurface shown in FIGS. 1 and 2, and QPI images, such as the images shown in any of FIGS. 3-10, or any combination thereof.

At 1102, optical system characteristics of an optical system are received. The optical system includes a light source, one or more lenses, and an imaging system. In some implementations, the optical system is configured to include a Fourier plan. The optical system characteristics include an optical path, a location of the Fourier plan relative to the imaging device and/or the light source, a wavelength and intensity of the light beam, and lens characteristics, as the optical systems 100A, 100B, 100C described with reference to FIGS. 1A-1C.

At 1104, optical parameters of at least one metasurface are received. The metasurface can include a plurality of metasurfaces, such as a pair of metasurfaces attached to a support surface (e.g., silica glass). The optical parameters of at least one metasurface can include a geometry of the optical support, a geometry and characterization of the metasurface including nanostructures (an array of subwavelength-scale meta-atoms) that realize wave front modulation by introducing abrupt phase change within a subwavelength thickness based on the orientation of the nanostructures (as described in FIGS. 2E and 2H) to modulate an incident wave front. The metasurface can have a compact and flexible wave front design, such as flat optical lenses, ultrathin holograms, nonlinear optical response enhancement and mathematical operations including spatial differentiation, composition of multiple (e.g., 2 or more) cascaded transmission metasurfaces separated by an optically transparent substrate. The metasurface can have a circular or a square cross-section, as described with reference to FIGS. 2A-2H. For example, the diameter of the circular optical support can be 2-5 cm and the fabricated metasurface area (included on the front face, a rear face, and/or one or more inner layers of the optical support) can have a circular, square, or rectangular shape with 0.3-1 cm diameter.

At 1106, an insertion location of the metasurface within the optical path of the optical system is selected to modulate an incident wavefront generated by the light source. In some implementations, selecting the insertion location of the metasurface within the optical path of the optical system can include positioning the metasurface approximately near a Fourier plan of the optical system, if the optical system includes a Fourier plan. In some implementations, selecting the insertion location of the metasurface within the optical path of the optical system can include positioning the metasurface pair (integrated in an optical support) in any position along the optical path, including adjacent to a front lens of the imaging device.

At 1108, the metasurface to imaging device distance can be adjusted by longitudinally and/or vertically displacing the metasurface and/or the imaging device. The distance adjustment can include a longitudinal and/or vertical displacement of the metasurface and/or the imaging device to a set of preselected locations, at a set frequency.

At 1110, images are acquired by the imaging device. In some implementations, if the metasurface to imaging device distance can be adjusted, the image acquisition is synchronized to the position adjustment, for example to capture at least one image with a first metasurface of a metasurface pair in focus and a second metasurface of the metasurface pair out of focus and a second image with the first metasurface of the metasurface pair out of focus and the second metasurface of the metasurface pair in focus. The images can include a differential interference contrast image or a quantitative phase gradient image.

At 1112, images are processed to determine imaging object characteristics. The images can be processed based on the optical system characteristics, the optical parameters of the at least one metasurface and based on the location of the metasurface within the optical path relative to the imaging device (including the longitudinal and vertical displacements). For example, by de-interspersing one captured image into 4 parts and interpolating the resulting parts, four DIC images with phase retardations of 0°, 90°, 180°, 270° can be determined. The DIC images can be used to calculate the unidirectional phase gradient via the three-or four-step phase shifting method. The phase can be retrieved in two steps. Firstly, the phase gradient with respect to x and y can be calculated with a three-step phase shifting method. The displacement of the metasurface in each direction can be considered to generate three images with phase retardations of −120°, 0°, 120° are taken to calculate the phase gradients Gₓ and G_{y} using Eq. 3, described with reference to FIG. 1A. The images captured when the metasurface moved along the optical axis can include three images with phase retardations around −120°, 0°, 120° in a certain area containing the targeted object are captured for both horizontal and vertical directions, respectively. Local phase retardations can be estimated pixel wise by evaluating the sinusoidal background in the images. The images can be processed using a generalized phase-stepping algorithm, which solves the phase gradients Gₓ and G_{y} in a least-squares manner. In the second step, the phase of the optical object can be reconstructed with a least-squares integration method based on finite difference. The phase gradients Gₓ and G_{y} are the difference between two pairs of horizontally and vertically sheared objects with a shearing distance 2Δ, respectively. The phase gradients can be represented by a matrix-vector multiplication:
g=A′ p

The phase gradients g=[vec(Gₓ) vec(G_{y})]^{T} can be vectorized phase gradients, A′ is the finite difference matrix considering the shearing distance 2Δ, p is the vectorized phase of the object. To reconstruct the phase of the optical object, a weighted l₂-norm total variation can be applied and the inverse problem is solved:

$$\hat{p} = {arg min}_{p ∈ {ℝ}^{MN}} {‖ {A}^{′} p - g ‖}_{2} + λ {‖ W \cdot {∇}_{x y} p ‖}_{2}$$

The term λ is the regularization parameter, W is a weighting matrix, · denotes element-wise multiplication, ∇_{xy}=[∇ₓ ∇_{y}]^{T} is the matrix of forward finite differences in the x and y directions. In some implementations, a cross section along a median of the phase object can be generated. The phase of the optical object can be processed to determine one or more characteristics of the imaging object (e.g., quantitative tissue characterization).

At 1114, the imaging object characteristics are displayed. For example, a two-dimensional representation of the phase object with unity amplitude can be displayed. In some implementations, the cross section along a median of the phase object can be displayed to indicate the intensity variation across the measured surface of the imaging object (e.g., as shown in FIGS. 6M and 7J). In some implementations, the display includes the determined characteristics of the imaging object.

The implementations described herein provide a compact, user-friendly, cost-effective solution for ultra-fast real-time quantitative phase imaging, which may lead to various applications in the fields of biological and biomedical research. For example, the example process 1100 provides the ability to control an integration of a metasurface in existing optical systems, to capture of and process DIC images with spatially varying phase retardations in one FOV, for sample quantitative characterization, including live specimens. Another advantage of the example process 1100 is that it provides accurate results without a precise alignment process between metasurface layers.

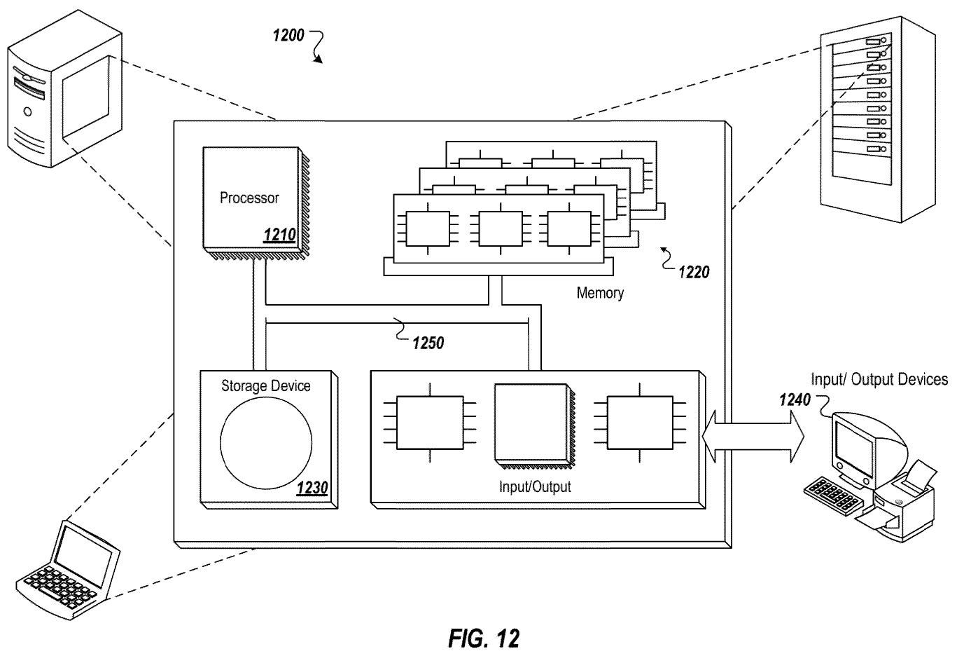

FIG. 12 depicts a diagram illustrating a computing system, in accordance with some example implementations. In some implementations, the current subject matter can be configured to be implemented in a system 1200, as shown in FIG. 12. The system 1200 can include a processor 1210, a memory 1220, a storage device 1230, and an input/output device 1240. Each of the components 1210, 1220, 1230 and 1240 can be interconnected using a system bus 1250. The processor 1210 can be configured to process instructions for execution within the system 1200. In some implementations, the processor 1210 can be a single-threaded processor. In alternate implementations, the processor 1210 can be a multi-threaded processor. The processor 1210 can be further configured to process instructions stored in the memory 1220 or on the storage device 1230, including receiving or sending information through the input/output device 1240. The memory 1220 can store information within the system 1200. In some implementations, the memory 1220 can be a computer-readable medium. In alternate implementations, the memory 1220 can be a volatile memory unit. In yet some implementations, the memory 1220 can be a non-volatile memory unit. The storage device 1230 can be capable of providing mass storage for the system 1200. In some implementations, the storage device 1230 can be a computer-readable medium. In alternate implementations, the storage device 1230 can be a floppy disk device, a hard disk device, an optical disk device, a tape device, non-volatile solid state memory, or any other type of storage device. The input/output device 1240 can be configured to provide input/output operations for the system 1200. In some implementations, the input/output device 1240 can include a keyboard and/or pointing device. In alternate implementations, the input/output device 1240 can include a display unit for displaying graphical user interfaces.

In some implementations, one or more application function libraries in the plurality of application function libraries can be stored in the one or more tables as binary large objects. Further, a structured query language can be used to query the storage location storing the application function library.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more user device computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include user devices and servers. A user device and server are generally, but not exclusively, remote from each other and typically interact through a communication network. The relationship of user device and server arises by virtue of computer programs running on the respective computers and having a user device-server relationship to each other.

Further non-limiting aspects or implementations are set forth in the following numbered examples:

Example 1: A computer-implemented method comprising: receiving optical system characteristics of an optical system, the optical system characteristics comprising an optical path, the optical system comprising a light source and an imaging system; receiving optical parameters of at least one metasurface; selecting a location of the metasurface within the optical path of the optical system to modulate an incident wavefront generated by the light source; and processing, based on the optical parameters of the at least one metasurface and based on the location of the metasurface within the optical path, an image acquired by the imaging system to determine one or more image properties.

Example 2: The computer-implemented method of example 1, wherein the metasurface comprises a plurality of metasurfaces.

Example 3: The computer-implemented method of any one of the preceding examples, wherein each of the plurality of metasurfaces comprises a multi-level metasurface attached to an optically transmissive substrate.

Example 4: The computer-implemented method of any one of the preceding examples, wherein selecting the location of the metasurface within the optical path of the optical system comprises: positioning the metasurface approximately near a Fourier plan of the optical system.

Example 5: The computer-implemented method of any one of the preceding examples, wherein selecting the location of the metasurface within the optical path of the optical system comprises: adjusting the location of the metasurface relative to the optical path or adjusting a position of the imaging system.

Example 6: The computer-implemented method of any one of the preceding examples, wherein the imaging system comprises a polarized camera, a microscope, or a mobile device.

Example 7: The computer-implemented method of any one of the preceding examples, wherein the image comprises a differential interference contrast image or a quantitative phase gradient image.

Example 8: A non-transitory computer-readable storage medium comprising programming code, which when executed by at least one data processor, causes operations comprising: receiving optical system characteristics of an optical system, the optical system characteristics comprising an optical path, the optical system comprising a light source and an imaging system; receiving optical parameters of at least one metasurface; selecting a location of the metasurface within the optical path of the optical system to modulate an incident wavefront generated by the light source; and processing, based on the optical parameters of the at least one metasurface and based on the location of the metasurface within the optical path, an image acquired by the imaging system to determine one or more image properties.

Example 9: The non-transitory computer-readable storage medium of example 8, wherein the metasurface comprises a plurality of metasurfaces.

Example 10: The non-transitory computer-readable storage medium of example 8 or 9, wherein each of the plurality of metasurfaces comprises a multi-level metasurface attached to an optically transmissive substrate.

Example 11: The non-transitory computer-readable storage medium of any one of the preceding examples, wherein selecting the location of the metasurface within the optical path of the optical system comprises: positioning the metasurface approximately near a Fourier plan of the optical system.

Example 12: The non-transitory computer-readable storage medium of any one of the preceding examples, wherein selecting the location of the metasurface within the optical path of the optical system comprises: adjusting the location of the metasurface relative to the optical path or adjusting a position of the imaging system.

Example 13: The non-transitory computer-readable storage medium of any one of the preceding examples, wherein the imaging system comprises a polarized camera, a microscope, or a mobile device.

Example 14: The non-transitory computer-readable storage medium of any one of the preceding examples, wherein the image comprises a differential interference contrast image or a quantitative phase gradient image.

Example 15: A system comprising: at least one data processor; and at least one memory storing instructions, which when executed by the at least one data processor, cause operations comprising: receiving optical system characteristics of an optical system, the optical system characteristics comprising an optical path, the optical system comprising a light source and an imaging system; receiving optical parameters of at least one metasurface; selecting a location of the metasurface within the optical path of the optical system to modulate an incident wavefront generated by the light source; and processing, based on the optical parameters of the at least one metasurface and based on the location of the metasurface within the optical path, an image acquired by the imaging system to determine one or more image properties.

Example 16: The system of any one of the preceding examples, wherein the metasurface comprises a plurality of metasurfaces.

Example 17: The system of example 15 or 16, wherein each of the plurality of metasurfaces comprises a multi-level metasurface attached to an optically transmissive substrate.

Example 18: The system of any one of the preceding examples, wherein selecting the location of the metasurface within the optical path of the optical system comprises: positioning the metasurface approximately near a Fourier plan of the optical system.

Example 19: The system of any one of the preceding examples, wherein selecting the location of the metasurface within the optical path of the optical system comprises: adjusting the location of the metasurface relative to the optical path or adjusting a position of the imaging system.

Example 20: The system of any one of the preceding examples, wherein the imaging system comprises a polarized camera, a microscope, or a mobile device and wherein the image comprises a differential interference contrast image or a quantitative phase gradient image.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. For example, the logic flows can include different and/or additional operations than shown without departing from the scope of the present disclosure. One or more operations of the logic flows can be repeated and/or omitted without departing from the scope of the present disclosure. Other implementations can be within the scope of the following claims.

What is claimed:

1. A computer-implemented method comprising:
receiving optical system characteristics of an optical system, the optical system characteristics comprising an optical path, the optical system comprising a light source and an imaging system;
receiving optical parameters of at least one metasurface;
selecting a location of the metasurface within the optical path of the optical system to modulate an incident wavefront generated by the light source; and
processing, based on the optical parameters of the at least one metasurface and based on the location of the metasurface within the optical path, an image acquired by the imaging system to determine one or more image properties.

2. The computer-implemented method of claim 1, wherein the metasurface comprises a plurality of metasurfaces.

3. The computer-implemented method of claim 2, wherein each of the plurality of metasurfaces comprises a multi-level metasurface attached to an optically transmissive substrate.

4. The computer-implemented method of claim 1, wherein selecting the location of the metasurface within the optical path of the optical system comprises:
positioning the metasurface approximately near a Fourier plan of the optical system.

5. The computer-implemented method of claim 1, wherein selecting the location of the metasurface within the optical path of the optical system comprises:
adjusting the location of the metasurface relative to the optical path or adjusting a position of the imaging system.

6. The computer-implemented method of claim 1, wherein the imaging system comprises a polarized camera, a microscope, or a mobile device.

7. The computer-implemented method of claim 1, wherein the image comprises a differential interference contrast image or a quantitative phase gradient image.

8. A non-transitory computer-readable storage medium comprising programming code, which when executed by at least one data processor, causes operations comprising:
receiving optical system characteristics of an optical system, the optical system characteristics comprising an optical path, the optical system comprising a light source and an imaging system;
receiving optical parameters of at least one metasurface;
selecting a location of the metasurface within the optical path of the optical system to modulate an incident wavefront generated by the light source; and
processing, based on the optical parameters of the at least one metasurface and based on the location of the metasurface within the optical path, an image acquired by the imaging system to determine one or more image properties.

9. The non-transitory computer-readable storage medium of claim 8, wherein the metasurface comprises a plurality of metasurfaces.

10. The non-transitory computer-readable storage medium of claim 9, wherein each of the plurality of metasurfaces comprises a multi-level metasurface attached to an optically transmissive substrate.

11. The non-transitory computer-readable storage medium of claim 8, wherein selecting the location of the metasurface within the optical path of the optical system comprises:
positioning the metasurface approximately near a Fourier plan of the optical system.

12. The non-transitory computer-readable storage medium of claim 8, wherein selecting the location of the metasurface within the optical path of the optical system comprises:
adjusting the location of the metasurface relative to the optical path or adjusting a position of the imaging system.

13. The non-transitory computer-readable storage medium of claim 8, wherein the imaging system comprises a polarized camera, a microscope, or a mobile device.

14. The non-transitory computer-readable storage medium of claim 8, wherein the image comprises a differential interference contrast image or a quantitative phase gradient image.

15. A system comprising:
at least one data processor; and
at least one memory storing instructions, which when executed by the at least one data processor, cause operations comprising:
receiving optical system characteristics of an optical system, the optical system characteristics comprising an optical path, the optical system comprising a light source and an imaging system;
receiving optical parameters of at least one metasurface;
selecting a location of the metasurface within the optical path of the optical system to modulate an incident wavefront generated by the light source; and
processing, based on the optical parameters of the at least one metasurface and based on the location of the metasurface within the optical path, an image acquired by the imaging system to determine one or more image properties.

16. The system of claim 15, wherein the metasurface comprises a plurality of metasurfaces.

17. The system of claim 16, wherein each of the plurality of metasurfaces comprises a multi-level metasurface attached to an optically transmissive substrate.

18. The system of claim 15, wherein selecting the location of the metasurface within the optical path of the optical system comprises:
positioning the metasurface approximately near a Fourier plan of the optical system.

19. The system of claim 15, wherein selecting the location of the metasurface within the optical path of the optical system comprises:
adjusting the location of the metasurface relative to the optical path or adjusting a position of the imaging system.

20. The system of claim 15, wherein the imaging system comprises a polarized camera, a microscope, or a mobile device and wherein the image comprises a differential interference contrast image or a quantitative phase gradient image.
